(19) United States
(12) Patent Application Publication
(10) Pub. No.: US 2024/0404339 A1
(43) Pub. Date: Dec. 5, 2024

(54) PHYSICAL ACCESS USING CLOUD TRANSACTION

(71) Applicant: ASSA ABLOY AB, Stockholm (SE)

(72) Inventors: Adam Augustyn, Krzeszowice (PL); Krzysztof Grzegorz Fabjanski, Bielsko-Biala (PL); Andrzej Bohdan Kostyk, Wieliczka (PL)

(21) Appl. No.: 18/729,980

(22) PCT Filed: Jan. 19, 2022
(86) PCT No.: PCT/EP2022/051067

§ 371 Date: Jul. 18, 2024

(51) Int. Cl. G07C 9/00; G07C 9/22; G07C 9/27; G08B 21/22

(52) U.S. Cl. CPC G07C 9/00571; G07C 9/00309; G07C 9/22; G07C 9/27; G08B 21/22; G07C 2209/08

(57) ABSTRACT

Systems and methods may be used for controlling physical access using a cloud transaction. A method may include receiving an authentication attempt for a user from a mobile device, and authenticating the user for access to a physical space based on the authentication attempt. The method may include receiving identification information corresponding to the user from an access control device, and sending authorization to the access control device to permit the user to access the physical space based on the authenticating the user.

### BACKGROUND

Physical control access systems may be used to restrict entry to physical spaces and permit entry to authorized individuals. For example, physical control access systems may control access to a room, a floor, a building, a safe (e.g., a floor safe, a wall safe, a freestanding safe, etc.), a cabinet, a vehicle, a case, etc. In typical systems, a keycard and reader are used, where a keycard is presented to the reader (e.g., inserted, touched to, held within a communication distance, etc.). The reader may determine if the keycard has proper authorization to access the controlled physical area. The reader may unlock a lock (e.g., a door lock) in response to determining that the keycard includes or has provided proper authorization.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system for cloud-based authentication for access of a physical resource in accordance with some embodiments.

FIG. 2 illustrates a system for identity verification in accordance with some embodiments.

FIG. 3 illustrates a swim lane diagram for cloud authentication for physical access in accordance with some embodiments.

FIGS. 4-6 illustrate flowcharts showing techniques for cloud-based authentication for access of a physical resource in accordance with some embodiments.

FIG. 7 illustrates generally an example of a block diagram of a machine upon which any one or more of the techniques discussed herein may perform in accordance with some embodiments.

### DETAILED DESCRIPTION

The systems and techniques described herein provide for cloud-based authentication for controlled physical access. The cloud-based authentication of the present systems and techniques provides increased security by limiting insecure communications, limiting over the air communications, and providing a more secure communication channel. The systems and techniques described herein provide improved convenience for users, by removing or reducing a need to present a physical keycard or device (e.g., by reducing the need to take a keycard out and hold it up to a reader, reducing the need to put a device in a credentialing mode, such as by opening an app, or the like). The present systems and techniques may provide further improvements to existing systems and techniques, such as reducing complexity of readers, providing real-time adjustments to authentication (e.g., adding or removing authenticated users, devices, or spaces), removing a need for a keycard to access a physical space (while maintaining or improving security access), streamlining physical access with digital resource access credentials, or the like.

In traditional physical control access systems there is a risk of exposing credentials. In an example, when credentials are exposed or stolen they must be immediately blocked or revoked in these traditional systems. When credential are presented to a reader, such as with an access card, the access card may be read by the reader using an insecure connection (e.g., contact, such as insertion of the card, key into the reader or cylinder, or contactless, such as Bluetooth low energy (BLE), near field communication (NFC), ultra-wideband (UWB), radio frequency identification (RFID), or the like).

During that secure communication a specific type of credential may be sent and authenticated by the reader device. In some systems the a security identity object (SIO) may be passed using secure messaging. In this example, the reader validates the SIO, for example by decrypting it and matching the bits (e.g., using the reader device or on a controller side). The final decision may be based on the matching the sequence of characters, which may be doubled encrypted at transit (e.g., messaging and SIO).

The systems and techniques described herein may use this authentication security, while conducting transactions in a secure cloud environment, for example without the traditional issue of exposing credentials in an insecure connection. Credentials may be encoded in the cloud, and authenticated using an out of band authentication process in the cloud. A card (or device) and reader may be used to identify a user after authentication. The reader may not perform any authentication actions, in an example. A sensitive transaction may be securely conduct in the cloud, and the outcome of the transaction may permit access or deny access to a physical space based on an identity of a user, such as by granting a temporary token.

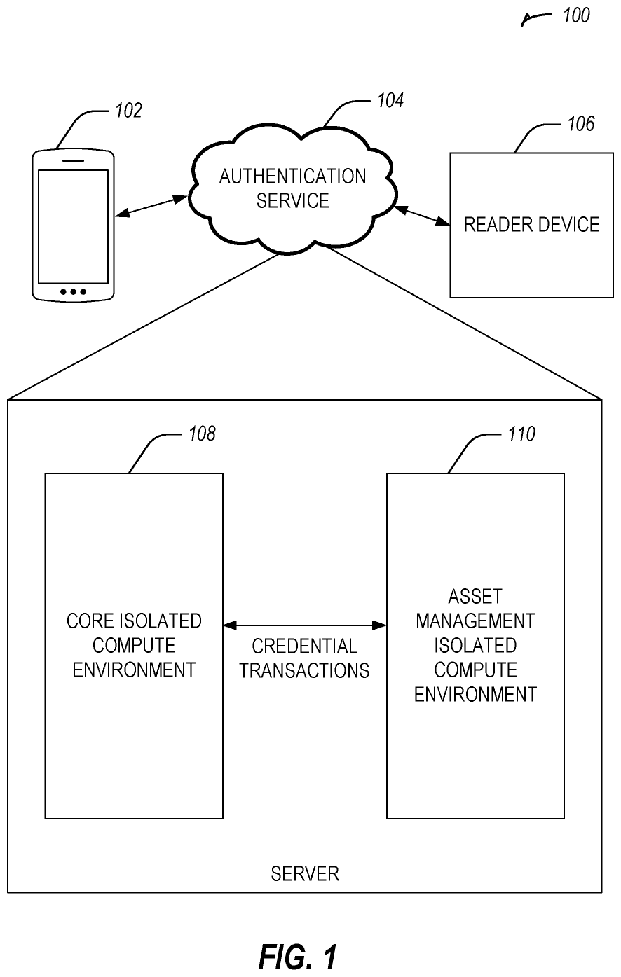

FIG. 1 illustrates a system 100 for cloud-based authentication for access of a physical resource in accordance with some embodiments. The system 100 illustrates a user device 102 (e.g., a computer, a mobile device such as a phone or tablet, an internet of things device, or the like) in communication with an authentication service 104. The authentication service may pass authenticated user identifiers to a reader device 106. In some examples, the user device 102 may not ever directly authenticate with the reader device 106. In some examples, the user device 102 may not ever communicate with the reader device 106, while in other examples the user device 102 may exchange communications for providing identity information with the reader device 106.

The authentication service 104 may include a core isolated compute environment 108 and an asset management isolated compute environment 110. The two environments may communicate credential transactions. The communications between the user device 102 and the authentication service 104 may be secure (e.g., end-to-end encrypted, confirmed via two factor authentication, using a secure connection, etc.). The authentication service 104 may communicate with the reader device 106 via a secure connection.

A user may use the user device 102 to authenticate with the authentication service 104. The authentication may be required periodically, such as once a day, once an hour, once every 24 hours, etc. The authentication may include requesting access over a time period to a physical resource (e.g., a room, a floor, a building, a safe, a cabinet, etc.). In an example, the authentication may include a request to access a digital resource (e.g., a website, a secure document, a secure environment, etc.). The authentication may be used to authenticate the user to more than one resource, for example with a single authentication. The user may authenticate the user device 102 in some examples (e.g., where the user device 102 is then required to be presented to the reader device 106 to access the physical resource). In other examples, the authentication may be for the user, in a device agnostic authentication (e.g., where the user may provide an identification to the reader device 106 without the user device 102 that was used to authenticate the user).

The authentication may include multi-factor authentication, password-based authentication, biometric authentication, token-based authentication, etc. When authenticating (or at an initial setup), the user's authentication credentials may be associated with identifying information for the user. By authenticating with the authentication service 104 before attempting to access a physical space, the user may save time and use a more convenient setup. Then, when the user is at the physical space, the reader device 106 may grant the user access to the physical space based on the previous authentication without the need to re-authenticate. The reader deice 106 may determine or receive an indication that the user was authenticated based on the user identifying information, which maybe confirmed at the reader device 106 or at the authentication service 104 via the reader device 106.

In an example, the identifying information may be encoded in an access card. In another example, the identifying information may correspond to biometric information of the user (e.g., fingerprint or facial recognition), a gait of the user, etc. In yet another example, the identifying information may be stored at the user device 102. The reader device 106 may access authentication information based on the previous authentication of the user, which may execute in the background at the reader device 106 periodically, may be stored at the reader device 106 (e.g., pushed from the authentication service 104 when authentication occurs), or may be pulled on demand from the authentication service 104 by the reader device 106 (e.g., in response to receiving the identifying information.

The system 100 improves security for authenticating users to access a physical space by not sending sensitive data over an insecure channel. A transaction may be performed in advance and may have a validity time (e.g., may be valid for a set period of time, such as an hour, a few hours, a day, 24 hours, a future date or time, etc.). Credentials used for a transaction may be ephemeral (e.g., not stored) and may be kept from leaving a secure enclave space (e.g., a server, the isolated compute environments 108 or 110, or the like). On the reader device 106, or on the user device 102 (which may be an access card in some examples), sophisticated circuitry may not be needed or used. For example, credentials may not be stored at the reader device 106 or the user device 102. The core 108 or the asset management 110 may be instantiated under separate tenant enclaves (e.g., secure environments), which may allow a class of federated access control scenarios to be created or used.

Further security for accessing the physical space includes disabling or deactivating authentication at the authentication service 104 (and thus at the reader device 106, when applicable), when a security event occurs (e.g., a theft or an unauthorized access of the user device 102). In an example, expiration of a last authentication timer may be expedited or allowed to expire without renewal. An unauthorized individual in possession of the user device 102, even during an authenticated period may not be able to access the physical space in some examples where the unauthorized individual is unable to provide identity information corresponding to the actual user. When the identity information does not correspond to an authentication, the reader device 106 may not recognize the user device 102 or may deny entry.

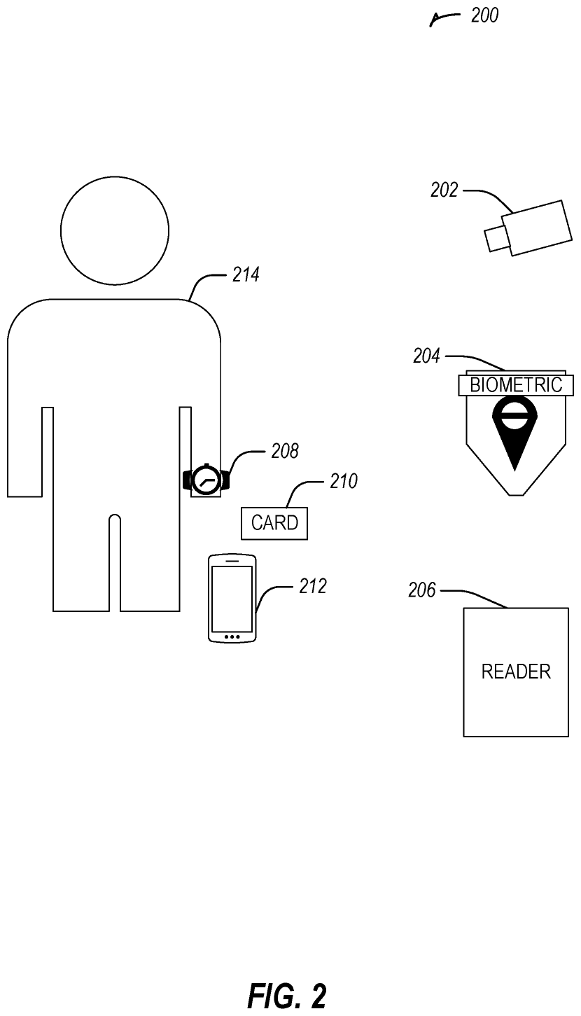

FIG. 2 illustrates a system diagram 200 for identity verification in accordance with some embodiments.

The diagram 200 illustrates example devices that may capture user identity information, such as a camera 202, a biometric reader 204, or a card or device reader 206. The diagram 200 illustrates identity devices, such as a watch 208 (or other wearable device), a card 210 (e.g., a digital card, such as a card with passive communication circuitry such as NFC, or other communication circuitry), or a mobile device 212, such as a phone, a tablet, a computer, etc. In some examples, a unique aspect of a user 214 may be used to identify the user 214. For example, a fingerprint, a retina, a gait, etc.

Various techniques for receiving identity information for the user 214 may be used, alone or in combination, such as using communication technologies such as infrared, NFC, time of flight, gait analysis, Bluetooth, or the like.

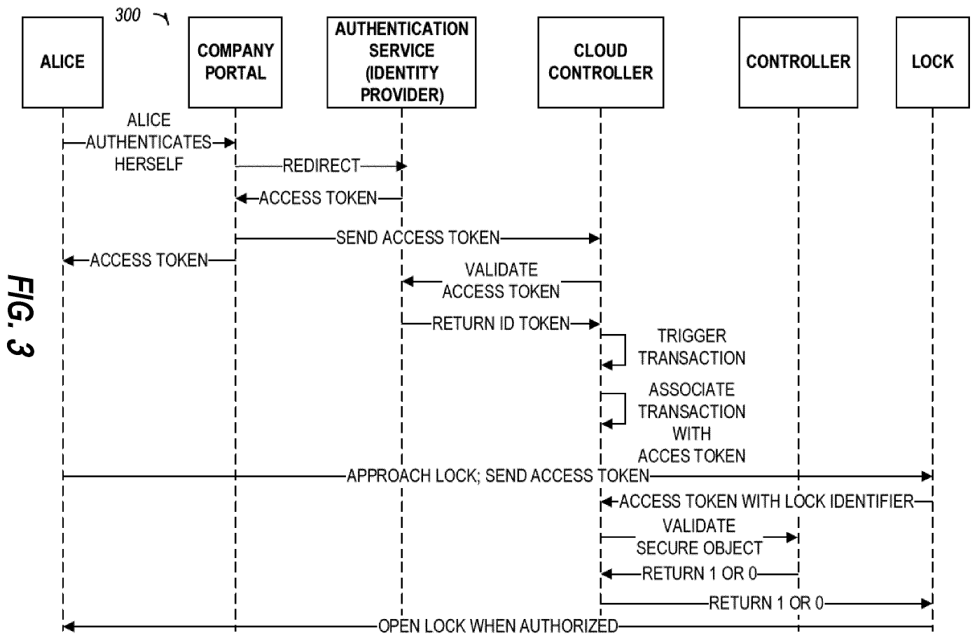

FIG. 3 illustrates a swim lane diagram 300 for cloud authentication for physical access in accordance with some embodiments. The swim lane diagram 300 illustrates an example set of devices that may be used, in some examples one or more of the illustrated devices may be omitted. The swim lane diagram 300 illustrates a user device (e.g., corresponding to a user “Alice”), a company portal (which may be a school, public access, club, government, or other type of portal), an authentication service, a cloud controller, a controller, and a lock (e.g., a reader device for controlling access to a physical space).

In the example authentication and physical space access described in the swim lane diagram 300, a user Alice authenticates with an authentication service before presenting identity information to a lock, which unlocks based on the prior authentication. Alice may authenticate (e.g., with a phone) in a logical authentication via a cloud service. The portal may redirect or pass on information corresponding to Alice's authentication attempt to an authentication service, which may act as an identity provider. The authentication service may provide an access token to the portal, for example after authenticating Alice. The access token may be sent to Alice's device or to a cloud controller. The cloud controller may validate the access token with the authentication service, which may send an identification token. In some examples, the user device (e.g., Alice's device) may have access to, create, or know the identification token. The cloud controller may trigger a transaction and associate the transaction with the access token after receiving the identification token. In an example, the above actions may occur at a first time or during a first time period, which may be separated in time from the below actions. For example, Alice may authenticate a device in the morning, for example before leaving for work, and then later after commuting to work, attempt to access a secured physical space.

When Alice approaches the lock, the lock may send an indication to the cloud controller, including the access token with a lock identifier. In some examples, the lock may send the lock identifier and the identification token (e.g., corresponding to Alice). In other examples, the lock may send the lock identifier and information identifying Alice (e.g., so that the cloud controller may identify Alice, which may not be done at the lock). In any of these examples, the lock identifier may be omitted (e.g., the lock may be identified at the cloud controller via an address, metadata, a particular channel, location information, etc.). Alice may be identified using any of the techniques described herein, for example with respect to FIG. 2 (e.g., via infrared reader, time of flight detector, camera, phone, watch, access card, identification card, biometric such as eye, fingerprint, gait, etc. (e.g., fingerprint reader on the handle of the door), or the like, indicating an identity of the person approaching,).

The cloud controller may validate a secure object with the controller. The controller (e.g., of the lock), may return a 1 or 0 or other answer (e.g., granting or denying access to the physical space controlled by the lock). The cloud controller may communicate with the lock when to open or remain locked. When the lock is instructed to open, the lock may open to allow Alice to access the physical space.

In an example, Alice may be a guest given access. In another example, Alice may be granted access to a new physical space by copying or mirroring authorization for access to other systems (e.g., other buildings, floors, rooms, safes, cabinets, etc.).

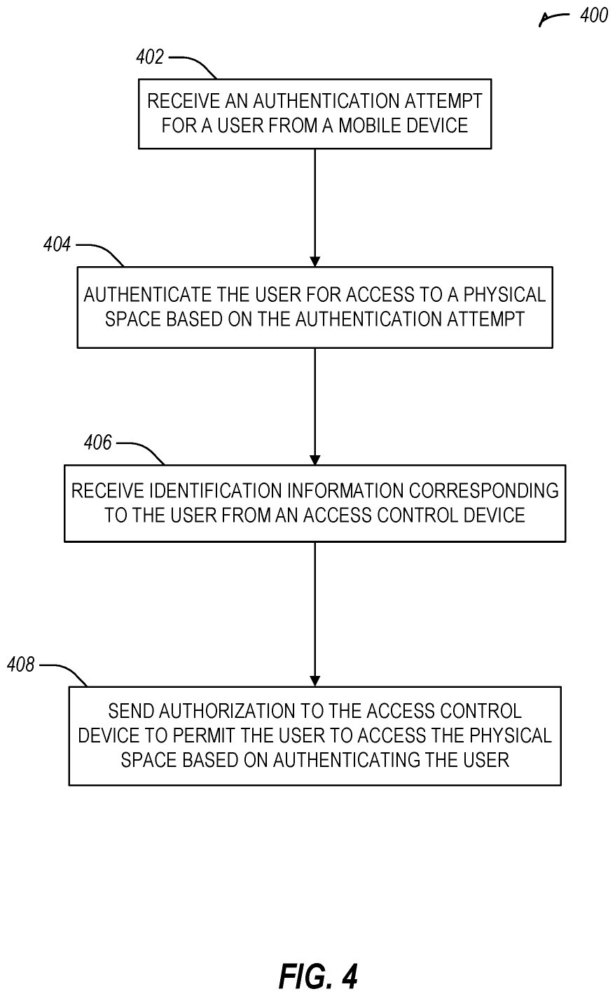

FIG. 4 illustrates a flowchart showing a technique 400 for cloud-based authentication for access of a physical resource in accordance with some embodiments. In an example, operations of the technique 400 may be performed by processing circuitry, for example by executing instructions stored in memory. The processing circuitry may include a processor, a system on a chip, or other circuitry (e.g., wiring). For example, technique 400 may be performed by processing circuitry of a device (or one or more hardware or software components thereof), such as those illustrated and described with reference to FIG. 1. The device may be a server.

The technique 400 includes an operation 402 to receive, for example during a time period, an authentication attempt for a user from a mobile device. In an example, the authentication attempt includes a request to access at least one digital resource, and wherein authenticating the user includes granting the user access to the at least one digital resource.

The technique 400 includes an operation 404 to authenticate, for example during the time period, the user for access to a physical space based on the authentication attempt.

The technique 400 includes an operation 406 to receive, for example after the time period, identification information corresponding to the user from an access control device. The identification information may include an image captured by a camera, a communication via a proximity communication protocol, biometric information, or the like.

The technique 400 includes an operation 408 to send authorization to the access control device to permit the user to access the physical space based on authenticating the user during the time period. In an example, the authorization may be sent to the access control device only when the identification information is received during a second time period based on the time period. In this example, the second time period may be separated from the time period by a third time period, and wherein the authorization is not sent to the access control device during the third time period. Operation 408 may include sending the authorization without reauthenticating the user after the time period. In an example, operation 408 includes sending the authorization in response to determining that the user is authorized to access the physical space.

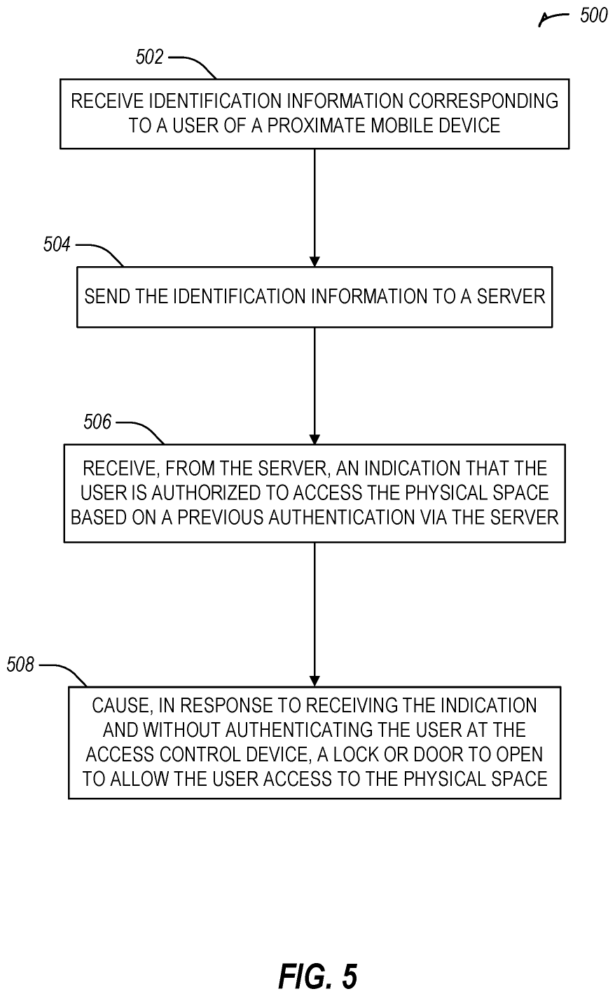

FIG. 5 illustrates a flowchart showing a technique 500 for cloud-based authentication for access of a physical resource in accordance with some embodiments. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 1. The device may be an access control device, such as a device controlling access to a physical space.

The technique 500 includes an operation 502 to receive identification information corresponding to a user of a proximate mobile device.

The technique 500 includes an operation 504 to send the identification information to a server. The identification information may include at least one of an image captured by a camera, a communication via a proximity communication protocol, biometric information, or the like.

The technique 500 includes an operation 506 to receive, from the server, an indication that the user is authorized to access the physical space based on a previous authentication via the server.

The technique 500 includes an operation 508 to cause, in response to receiving the indication and without authenticating the user at the access control device, a lock or door to open to allow the user access to the physical space.

In an example, the access control device may not include authentication circuitry. In an example, the technique 500 may include determining that the proximate mobile device is within a proximity communication range, and in response, sending an indication to the proximate mobile device requesting the identification information.

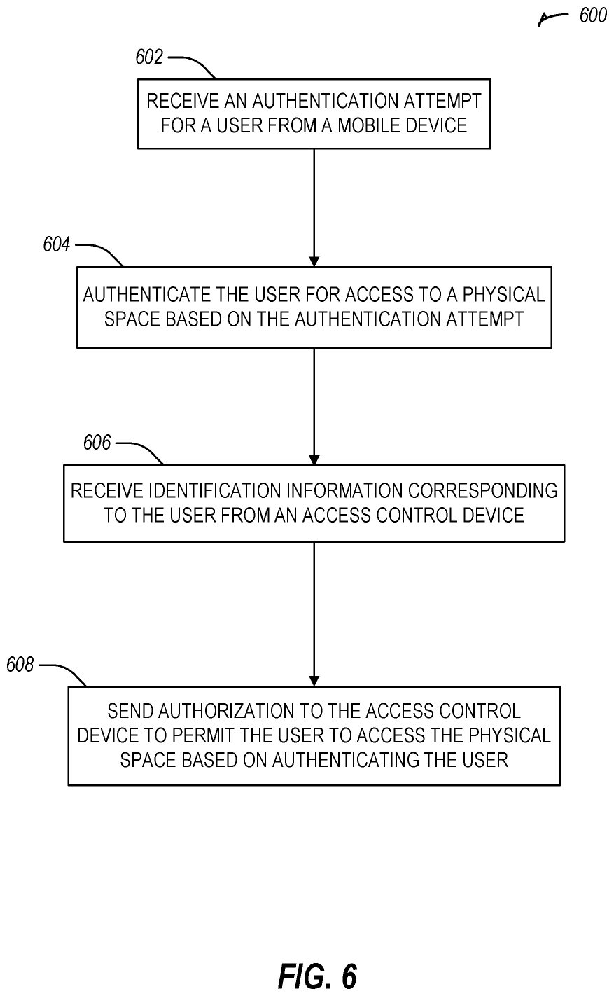

FIG. 6 illustrates a flowchart showing a technique 600 for cloud-based authentication for access of a physical resource in accordance with some embodiments. In an example, operations of the technique 600 may be performed by processing circuitry, for example by executing instructions stored in memory. The processing circuitry may include a processor, a system on a chip, or other circuitry (e.g., wiring). For example, technique 600 may be performed by processing circuitry of a device (or one or more hardware or software components thereof), such as those illustrated and described with reference to FIG. 1. The device may be a mobile device, such as a mobile phone, a tablet, a watch, an internet of things device, or the like.

The technique 600 includes an operation 602 to sending authentication information, via communication with a server, corresponding to a user of the mobile device to access a physical space. The authentication information may include a request to access at least one digital resource, and further comprising receiving access to the at least one digital resource.

The technique 600 includes an operation 604 to determining that the mobile device is within a specified proximity of an access control device controlling access to the physical space.

The technique 600 includes an operation 606 to sending identification information for the user, different from authentication information, to the access control device. The identification information may include at least one of an image captured by a camera, a communication via a proximity communication protocol, biometric information, or the like.

The technique 600 includes an operation 608 to logging a user access to the physical space in response to the access control device granting access to the physical space. The access to the physical space may be granted without authenticating the user at the access control device.

The technique 600 may include receiving an indication of authentication of the user. For example, the access to the physical space may be granted by the access control device only when the identification information is received during a time period after receiving the indication of the authentication. In an example, the time period may be separated from the receiving the indication of the authentication by a second time period. The access to the physical space may not be granted during the second time period. In an example, the time period may be separated from the receiving the indication of the authentication by a second time period. In this example, the access to the physical space is not granted during the second time period.

The technique 600 may include receiving an indication from the access control device requesting the identification information. In an example, the technique 600 may include providing a notification to the user that the access to the physical space has been granted by the access control device, the notification including audible, visual, or haptic feedback.

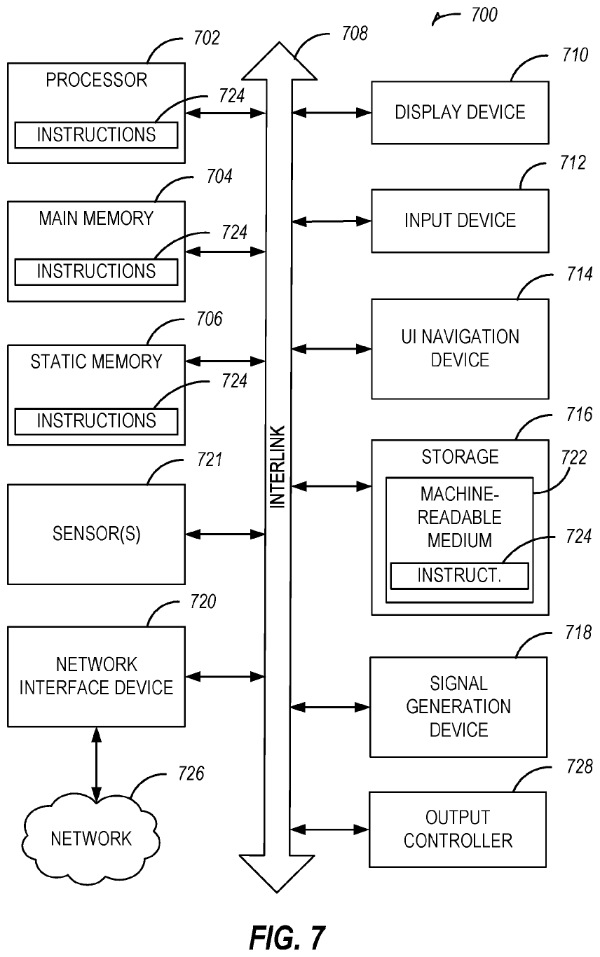

FIG. 7 illustrates generally an example of a block diagram of a machine 700 upon which any one or more of the techniques (e.g., methodologies) discussed herein may perform in accordance with some embodiments, such as computing device 102 or a device operating in the cloud 112. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, alphanumeric input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 that is non-transitory on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

Example 1 is a method performed at a server, the method comprising: receiving, during a time period, an authentication attempt for a user from a mobile device; authenticating, during the time period, the user for access to a physical space based on the authentication attempt; receiving, after the time period, identification information corresponding to the user from an access control device; and sending authorization to the access control device to permit the user to access the physical space based on the authenticating of the user during the time period.

In Example 2, the subject matter of Example 1 includes, wherein the authentication attempt includes a request to access at least one digital resource, and wherein authenticating the user includes granting the user access to the at least one digital resource.

In Example 3, the subject matter of Examples 1-2 includes, wherein the authorization is sent to the access control device only when the identification information is received during a second time period based on the time period.

In Example 4, the subject matter of Example 3 includes, wherein the second time period is separated from the time period by a third time period, and wherein the authorization is not sent to the access control device during the third time period.

In Example 5, the subject matter of Examples 1-4 includes, wherein the identification information includes at least one of an image captured by a camera, a communication via a proximity communication protocol, or biometric information.

In Example 6, the subject matter of Examples 1-5 includes, wherein sending the authorization to the access control device includes sending the authorization without reauthenticating the user after the time period.

In Example 7, the subject matter of Examples 1-6 includes, wherein sending the authorization to the access control device includes sending the authorization in response to determining that the user is authorized to access the physical space.

Example 8 is a method performed at an access control device controlling access to a physical space, the method comprising: receiving identification information corresponding to a user of a proximate mobile device; sending the identification information to a server; receiving, from the server, an indication that the user is authorized to access the physical space based on a previous authentication via the server; and causing, in response to receiving the indication and without authenticating the user at the access control device, a lock or door to open to allow the user access to the physical space.

In Example 9, the subject matter of Example 8 includes, wherein the access control device does not include authentication circuitry.

In Example 10, the subject matter of Examples 8-9 includes, wherein the identification information includes at least one of an image captured by a camera, a communication via a proximity communication protocol, or biometric information.

In Example 11, the subject matter of Examples 8-10 includes, determining that the proximate mobile device is within a proximity communication range, and in response, sending an indication to the proximate mobile device requesting the identification information.

Example 12 is a method performed using a mobile device, the method comprising: sending authentication information, via communication with a server, corresponding to a user of the mobile device to access a physical space; determining that the mobile device is within a specified proximity of an access control device controlling access to the physical space; sending identification information for the user, different from authentication information, to the access control device; and logging a user access to the physical space in response to the access control device granting access to the physical space.

In Example 13, the subject matter of Example 12 includes, wherein the authentication information includes a request to access at least one digital resource, and further comprising receiving access to the at least one digital resource.

In Example 14, the subject matter of Examples 12-13 includes, receiving an indication of authentication of the user.

In Example 15, the subject matter of Example 14 includes, wherein the access to the physical space is granted by the access control device only when the identification information is received during a time period after receiving the indication of the authentication.

In Example 16, the subject matter of Example 15 includes, wherein the time period is separated from the receiving the indication of the authentication by a second time period, and wherein the access to the physical space is not granted during the second time period.

In Example 17, the subject matter of Examples 12-16 includes, wherein the identification information includes at least one of an image captured by a camera, a communication via a proximity communication protocol, or biometric information.

In Example 18, the subject matter of Examples 12-17 includes, wherein the access to the physical space is granted without authenticating the user at the access control device.

In Example 19, the subject matter of Examples 12-18 includes, receiving an indication from the access control device requesting the identification information.

In Example 20, the subject matter of Examples 12-19 includes, providing a notification to the user that the access to the physical space has been granted by the access control device, the notification including audible, visual, or haptic feedback.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. A method performed at a server, the method comprising:
receiving, during a time period, an authentication attempt for a user from a mobile device;
authenticating, during the time period, the user for access to a physical space based on the authentication attempt;
receiving, after the time period, identification information corresponding to the user from an access control device; and
sending authorization to the access control device to permit the user to access the physical space based on the authenticating of the user during the time period.

2. The method of claim 1, wherein the authentication attempt includes a request to access at least one digital resource, and wherein authenticating the user includes granting the user access to the at least one digital resource.

3. The method of claim 1, wherein the authorization is sent to the access control device only when the identification information is received during a second time period based on the time period.

4. The method of claim 3, wherein the second time period is separated from the time period by a third time period, and wherein the authorization is not sent to the access control device during the third time period.

5. The method of claim 1, wherein the identification information includes at least one of an image captured by a camera, a communication via a proximity communication protocol, or biometric information.

6. The method of claim 1, wherein sending the authorization to the access control device includes sending the authorization without reauthenticating the user after the time period.

7. The method of claim 1, wherein sending the authorization to the access control device includes sending the authorization in response to determining that the user is authorized to access the physical space.

8. A method performed at an access control device controlling access to a physical space, the method comprising:
receiving identification information corresponding to a user of a proximate mobile device;
sending the identification information to a server;
receiving, from the server, an indication that the user is authorized to access the physical space based on a previous authentication via the server; and
causing, in response to receiving the indication and without authenticating the user at the access control device, a lock or door to open to allow the user access to the physical space.

9. The method of claim 8, wherein the access control device does not include authentication circuitry.

10. The method of claim 8, wherein the identification information includes at least one of an image captured by a camera, a communication via a proximity communication protocol, or biometric information.

11. The method of claim 8, further comprising, determining that the proximate mobile device is within a proximity communication range, and in response, sending an indication to the proximate mobile device requesting the identification information.

12. A method performed using a mobile device, the method comprising:
sending authentication information, via communication with a server, corresponding to a user of the mobile device to access a physical space;
determining that the mobile device is within a specified proximity of an access control device controlling access to the physical space;
sending identification information for the user, different from authentication information, to the access control device; and
logging a user access to the physical space in response to the access control device granting access to the physical space.

13. The method of claim 12, wherein the authentication information includes a request to access at least one digital resource, and further comprising receiving access to the at least one digital resource.

14. The method of claim 12, further comprising receiving an indication of authentication of the user.

15. The method of claim 14, wherein the access to the physical space is granted by the access control device only when the identification information is received during a time period after receiving the indication of the authentication.

16. The method of claim 15, wherein the time period is separated from the receiving the indication of the authentication by a second time period, and wherein the access to the physical space is not granted during the second time period.

17. The method of claim 12, wherein the identification information includes at least one of an image captured by a camera, a communication via a proximity communication protocol, or biometric information.

18. The method of claim 12, wherein the access to the physical space is granted without authenticating the user at the access control device.

19. The method of claim 12, further comprising, receiving an indication from the access control device requesting the identification information.

20. The method of claim 12, further comprising providing a notification to the user that the access to the physical space has been granted by the access control device, the notification including audible, visual, or haptic feedback.
